(19) United States
(12) Patent Application Publication
(10) Pub. No.: US 2018/0336752 A1
(43) Pub. Date: Nov. 22, 2018

(54) SYSTEMS AND METHODS FOR COIN RECYCLING

(71) Applicant: Tidel Engineering L.P., Carrollton, TX (US)

(72) Inventors: Flynt Moreland, Plano, TX (US); Steve Remis, Coppell, TX (US); Brian Woodworth, Coppell, TX (US)

(73) Assignee: Tidel Engineering L.P., Carrollton, TX (US)

(21) Appl. No.: 15/942,103

(22) Filed: Mar. 30, 2018

Related U.S. Application Data
(60) Provisional application No. 62/478,987, filed on Mar. 30, 2017.

(51) Int. Cl. G07D 3/14; G07D 5/02; G07D 5/08

(52) U.S. Cl. CPC G07D 3/14; G07D 3/16; G07D 5/08; G07D 5/02

(57) ABSTRACT

Implementations described and claimed herein provide systems and methods for sorting disc objects, such as coins, into customizable combinations. In one implementation, a singulator is configured to isolate a disc object from a batch of disc objects. A rail is disposed relative to the singulator, and gravity directs the disc object through the singulator onto the rail. A discriminator determines a size and a composition of the disc object as the disc object travels along the rail. The discriminator determines a denomination and a validity of the disc object based on the size and the composition. A sorter is in communication with the discriminator. The sorter ejects the disc object into a chute corresponding to the denomination and the validity.

### CROSS-REFERENCE TO RELATED APPLICATIONS

The present application claims benefit of priority under 35 U.S.C. § 119 to U.S. Provisional Patent Application No. 62/478,987, entitled “SYSTEMS AND METHODS FOR COIN RECYCLING” and filed Mar. 30, 2017, which is incorporated by reference in its entirety herein.

### TECHNICAL FIELD

Aspects of the present disclosure relate to coin recycling and more particularly to systems and methods for sorting coins into customizable denomination combinations.

### BACKGROUND

Recycling systems accept disc objects, such as coins, tokens, and the like, in bulk and sort each of the individual disc objects based on selected characteristics for storage and/or subsequent use. For example, individual coins may be sorted according to denomination for storage and/or subsequent use. Conventional systems sort the coins based on denomination using manifolds positioned over chutes. The manifolds physically restrict which coins can enter each chute based on a diameter of the coin and thus the denomination. Stated differently, because denomination is generally tied to coin diameter, coins of a particular denomination may be directed into a corresponding chute by either covering the chute with a manifold having an opening sized to fit the coin diameter of the denomination or knocking the coins of descending diameter into a series of chutes. Such conventional systems, however, are typically error prone, and adjusting the system to accommodate varying diameter sorting needs, is often challenging. For example, to sort disc objects based on diameter (e.g., a different denomination), a new manifold is typically manufactured with an opening sized according to the new diameter. The old manifold is then manually replaced by the new manifold. Such a process is often time intensive and inefficient. Additionally, conventional systems prevent the use of multiple chutes for disc objects of the same diameter because the first manifold would capture all the disc objects having that diameter. Other conventional systems merely analyze the disc objects before reaching the manifold, with unrecognized objects being rejected into the first chute before diameter-based sorting takes place. It is with these observations in mind, among others, that various aspects of the present disclosure were conceived and developed.

### SUMMARY

Implementations described and claimed herein address the forgoing problems, among others, by providing systems and methods for sorting disc objects, such as coins, into customizable combinations. In one implementation, a batch of coins is received into a coin singulator. A coin is isolated from the batch of coins on a coin rail using the coin singulator. A size of the coin is measured using a set of sensors as the coin travels along the coin rail, and one or more voltage responses to one or more signals is measured as the coin passes between a set of inductors on the coin rail. A denomination and a validity of the coin are determined based on the size and the one or more voltage responses. The coin is ejected into a chute corresponding to the denomination and the validity.

In another implementation, a singulator is configured to isolate a disc object from a batch of disc objects. A rail is disposed relative to the singulator, and gravity directs the disc object through the singulator onto the rail. A discriminator determines a size and a composition of the disc object as the disc object travels along the rail. The discriminator determines a denomination and a validity of the disc object based on the size and the composition. A sorter is in communication with the discriminator. The sorter ejects the disc object into a chute corresponding to the denomination and the validity.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is a perspective view of an example coin recycling system.

FIG. 2 illustrates an example coin singulator.

FIG. 3 is a perspective view of a coin input system of the coin singulator.

FIGS. 4A-4B are an isometric view and a cross-sectional view, respectively, of a coin input feeder and a partition of the coin input system. The coin input feeder is shown transparent in FIG. 4A for clarity.

FIGS. 5A-5B are an isometric view and a cross-sectional view, respectively, of a coin wheel and a bowl of the coin input system. The bowl is shown transparent in FIG. 5A for clarity.

FIG. 6 is a front view of the wheel, a wheel top plate, a wheel backing, and a motor assembly of the coin input system.

FIG. 7 is a rear perspective view of the wheel, the wheel backing, and the motor assembly.

FIG. 8 is top cross-sectional view of the bowl and the motor assembly. The wheel and the wheel backing are not shown for clarity.

FIGS. 9A-9B are a front and a rear view, respectively, of an example discriminator.

FIG. 10 is a perspective view of the discriminator.

FIG. 11 is a flow chart illustrating example operations for determining a coin diameter.

FIGS. 12A-12B are example graphs illustrating responses captured by a set of optical sensors for a first coin type and a second coin type, respectively.

FIG. 12C is a graph showing a relationship between a diameter of a coin verses a chord of the coin.

FIG. 13 is a flow chart illustrating example operations for determining a coin denomination.

FIG. 14 is a diagram illustrating a coin passing through a set of inductors for determining a denomination of the coin.

FIGS. 15A-C are example graphs illustrating responses to signals from a set of inductors for a first coin type and a second coin type.

FIG. 16 illustrates an example coin sorter.

FIG. 17 is a detailed view of a portion of the coin sorter.

FIG. 18 is a flow chart illustrating example operations for sorting a batch of coins into customizable combinations.

FIG. 19 is an example computing system for implementing various aspects of the presently disclosed technology.

### DETAILED DESCRIPTION

Aspects of the present disclosure involve systems and methods for recycling disc objects, such as coins, tokens, and/or the like. In one aspect, a coin recycling system receives a plurality of mixed coins having various denominations and transports each of the coins onto a coin rail using gravity. The coin recycling system determines a composition and a diameter of the coin as it travels along the coin rail. Using the composition and the diameter, the coin recycling system determines a denomination and a validity of the coin. The coin is sorted into a designated chute based on the determined denomination and validity. For example, non-compliant coins (e.g., damaged coins, coins with an unacceptable denomination, etc.) are directed into a rejection chute, and compliant coins are directed into one or more chutes corresponding to their determined denomination. Each of the chutes may direct the coins into a bin, such as a hopper, for storage and/or subsequent use.

The various systems and methods disclosed herein generally provide for sorting disc objects into customizable combinations based on one or more characteristics of the disc objects. The example implementations discussed herein reference coins sorted into customizable denomination combinations. However, it will be appreciated by those skilled in the art that the presently disclosed technology is applicable to other disc objects, such as tokens, and other customizable combinations. Further, the disc objects may have a variety of shapes, including, but not limited to, circular, hendecagonal, dodecagonal, elliptical, polygonal, or the like.

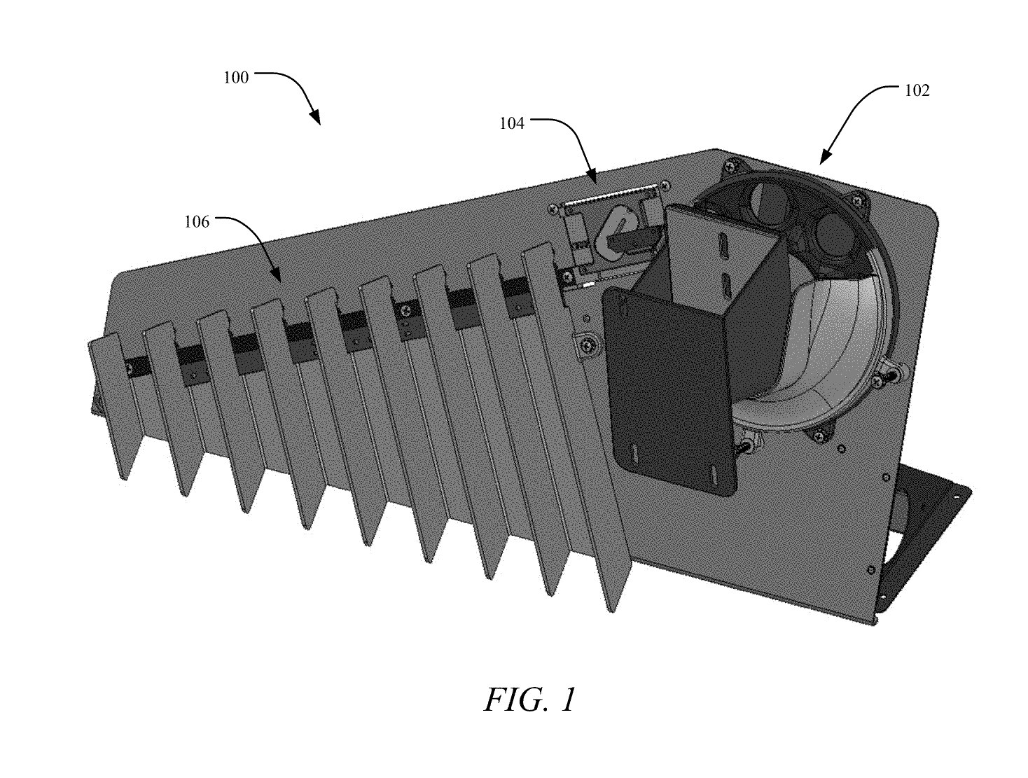

To begin a detailed description of an example coin recycling system 100, reference is made to FIG. 1. In one implementation, a user selects a customized combination of coin types to sort. For example, the user may select which denominations to sort into bins and how many bins of each denomination. The coin recycling system 100 receives a batch of coins and places each of the coins individually on a coin rail. A size of the coin is measured using a set of optical through-beam sensors. The coin recycling system 100 measures responses to a plurality of signals of different frequencies as the coin passes through a set of inductors. The measured size and responses are compared to expected values for each coin type selected for sorting to determine the coin type of the coin. If the coin type is unrecognized or otherwise not a selected coin type, the coin passes through the coin recycling system 100. Otherwise, the coin is ejected from the coin rail into a chute corresponding to the coin type, where it is directed into a bin for storage and/or subsequent use. The coin recycling system 100 manages batches of coins, including configuration, startup, discrimination, sortation, and accounting. It will be appreciated that multiple coins will be in various locations in the coin recycling system 100 simultaneously and in different stages of singulation, discrimination, and sorting, such that the various operations described herein generally occur in parallel.

In one implementation, the coin recycling system 100 includes a coin singulator 102, a coin discriminator 104, and a coin sorter 106. The coin singulator 102 receives a batch of coins having a mixed denomination and/or validity and separates each of the coins. More particularly, the batch of mixed coins is received into an input coin feeder of the coin singluator 102. The coins travel through a bowl and onto a wheel where coins are individually captured into coin holes on the wheel. The wheel is turned by a motor which carries each coin to the top of the wheel where the coin then passes through a slot in the wheel and onto a coin rail using gravity.

The coin passes through the coin discriminator 104 including one or more sensors, such as one or more optical sensors and/or one or more inductors. The responses of the sensors as the coin passes are measured against values stored in a table or other model to determine a denomination and validity of the coin. Based on the denomination and validity, a chute is designated for the coin.

If the coin is rejected, the coin passes through the coin sorter 106 and exits via a rejection chute. If the coin is not rejected it travels along the coin rail until it has reached its designated coin chute. An ejector, such as a solenoid, peizo actuator, 4-bar, or the like, positioned at each of the coin chutes pushes a plunger against the coin to direct the coin into the designated chute.

The table may be updated to customize denomination combinations. For example, if a new mintage of a coin is introduced, various values for that mintage may be input into the table to sort the coin without any hardware changes. Further, a user may decide to change the combination of coins being sorted into bins. For example, the coin recycling system 100 may have been sorting pennies, nickels, dimes, quarters, and half dollars into one bin each. The user may decide to eliminate the acceptance of the half dollars and include two bins of quarters. Again to make the change, the table may be updated accordingly without any hardware changes. In some cases, the values for a new coin may not be available for input into the table. Here, the coin recycling system 100 may be calibrated to obtain and store values for the new coin by deploying the new coin through the coin recycling system 100 in calibration runs and setting a corresponding chute. As such, the coin recycling system 100 singulates, discriminates, and sorts a batch of coins into customizable combinations without a hardware change. In one implementation, the coin is directed through the coin singulator 106 and onto the coin rail solely under the force of gravity.

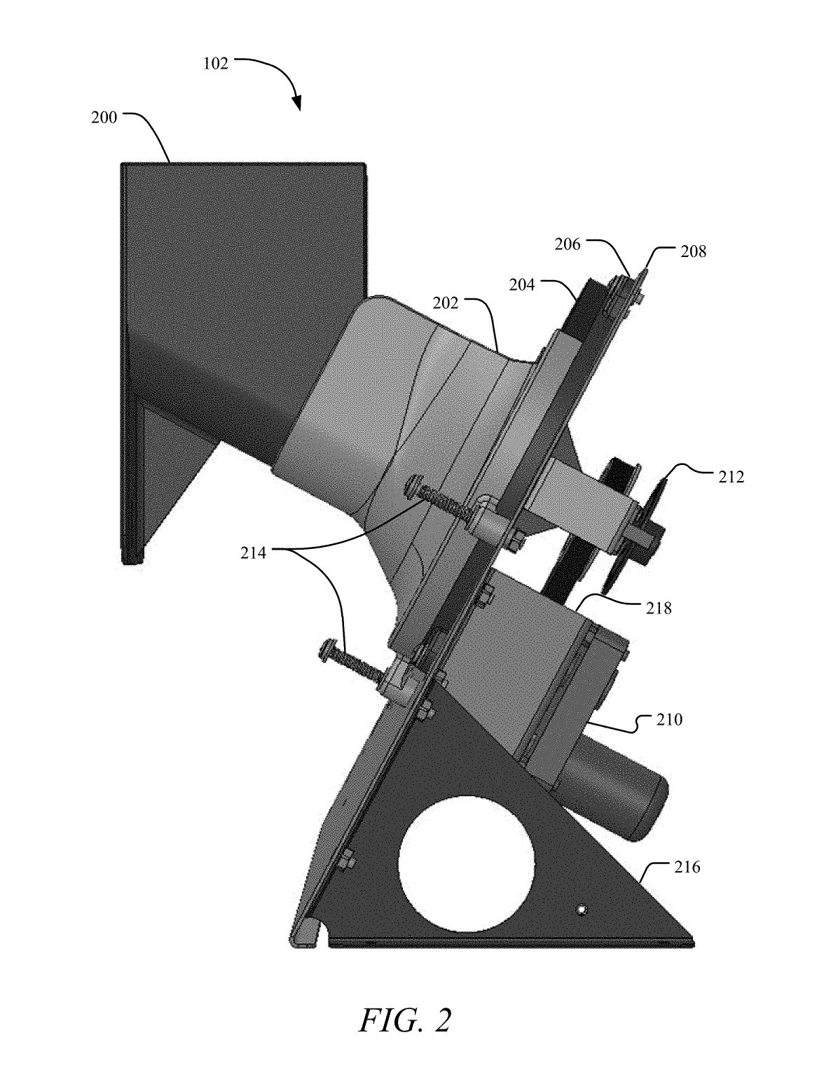

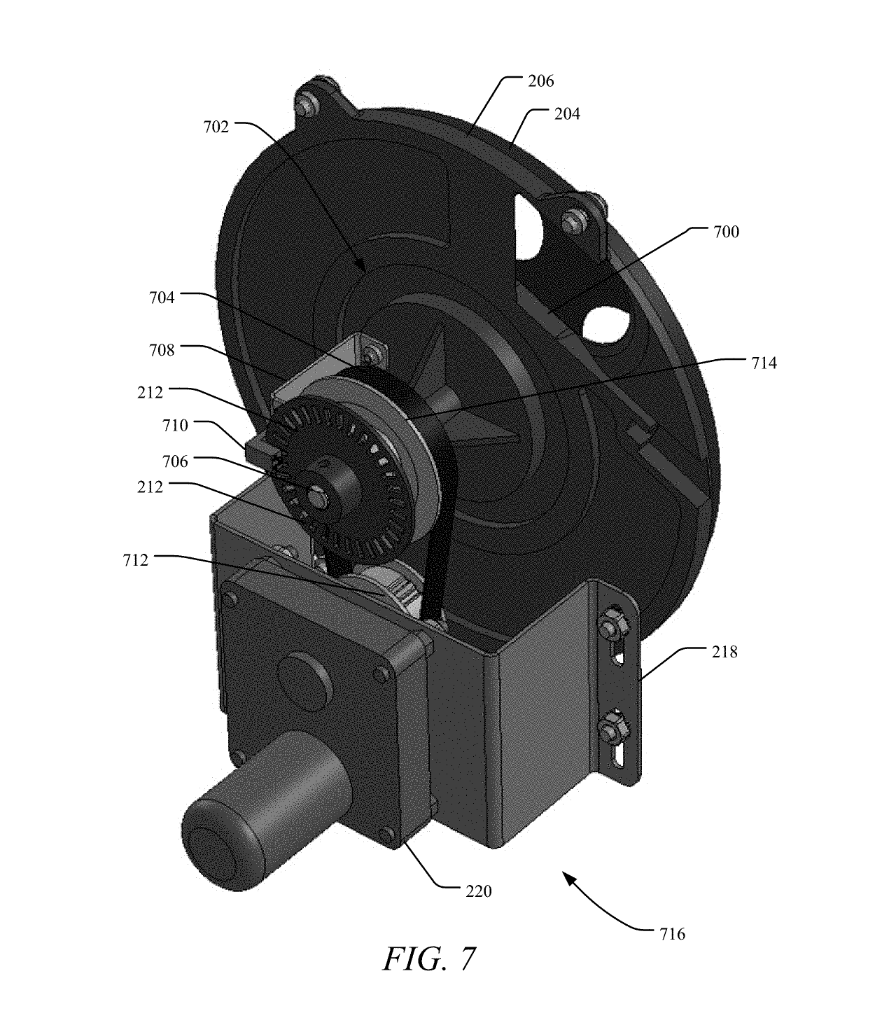

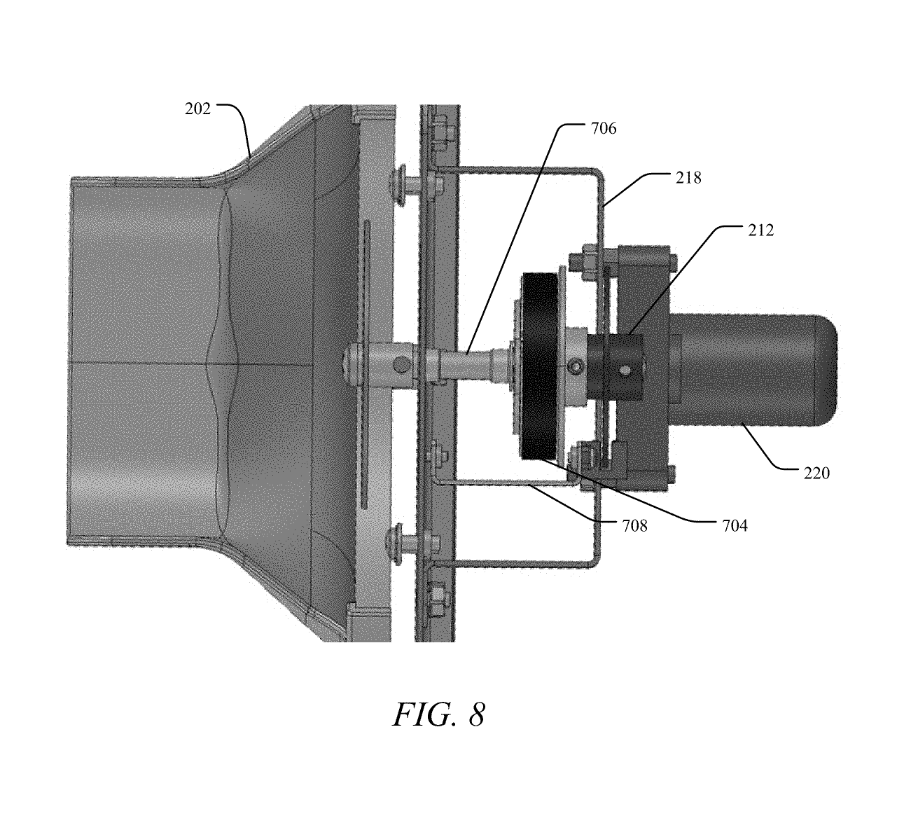

For a detailed description of the coin singulator 102, reference is made to FIGS. 2-9. Turning first to FIG. 2, which is a detailed view of the coin singulator 102, an input feeder 200 directs a batch of mixed coins into an input bowl 202. In one implementation, the input bowl 202 is mounted to a back plate 208 relative to a wheel 204 and a wheel backing 206. A stand 216 is connected to the back plate 208, providing support for the coin singulator 102, as well as other components of the coin recycling system 100. The input bowl 202 directs the coins to the wheel 204, where they are each positioned against the wheel 204 in an upright orientation generally parallel to the wheel 204 for individual capture in one or more holes of the wheel 204. As described herein, the wheel 204 rotates through the batch of coins collected in the input bowl 202, with each hole in the wheel 204 capturing a single coin and any uncaptured coins falling back into the input bowl 202. The wheel backing 206 permits one coin at a time to fall through the wheel backing 206 into the back plate 208 and further onto a coin rail. The coin singulator 102 thus separates an individual coin from the batch held in the input bowl 202 using the wheel 204 and transports the coin separately onto the coin rail using gravity. In one implementation, the coin is isolated by the coin singulator 102 and directed onto the coin rail under the force of gravity.

To prevent jamming and facilitate the separation and transport of each of the coins, the input bowl 202 may be mounted to the back plate 208 in a floating arrangement. More specifically, in one implementation, the input bowl 202 is connected to the back plate 208 with one or more springs 214. Each of the springs 214 may extend around a body, such as a screw, nail, or the like. The elasticity of the springs 214 permits the input bowl 202 to move freely in the floating arrangement relative to the back plate 208, the wheel 204, and/or the wheel backing 206, while remaining mounted to the back plate 208. The floating arrangement of the connection of the input bowl 202 to the back plate 208 maintains the coins in a close proximity to a face of the wheel 204 while preventing the coins from jamming into the input bowl 202. Stated differently, when coins begin to collect in a manner that may cause a jam, the floating arrangement permits the collection of coins to displace the input bowl 202 in a direction away from the wheel 204, thereby dispersing the coins and preventing a jam. In one implementation, the coin recycling system 100 is further configured to address jamming by detecting a jam based on a speed and/or torque of the wheel 204. Where a jam is detected, a speed and/or rotation direction of the wheel 204 may be adjusted to break up the jam.

The wheel 204 is rotated using one or more motors 210. In one implementation, the motor 210 is mounted to the wheel 204 using a motor bracket 218, which is mounted to the back plate 208. An encoder 212 controls the speed at which the motor 210 rotates the wheel 204. In one implementation, the encoder 212 sets a range of speeds determined based on calibration parameters for determining coin diameter using the coin discriminator 106. More particularly, the encoder 212 may set a speed of the wheel 204 to transport the coins to the coin discriminator 106 within a range of coin output speeds that the coin travels from the coin singulator 102 that facilitates measurement of the coin diameter. Alternatively or additionally, the speed may be set based on a throughput rate of capturing and transporting the coins to the coin discriminator 106. In one implementation, the encoder 212 instructs the motor 210 to rotate the wheel 204 at a speed optimized for achieving a throughput rate of approximately 240 coins per minute. The speed of the wheel 204 may automatically adjust dynamically during use to maintain the throughput rate. For example, as the wheel 204 rotates, there may be empty coin holes at various times, thereby causing the wheel 204 to adjust to a relatively higher speed to maintain the throughput rate.

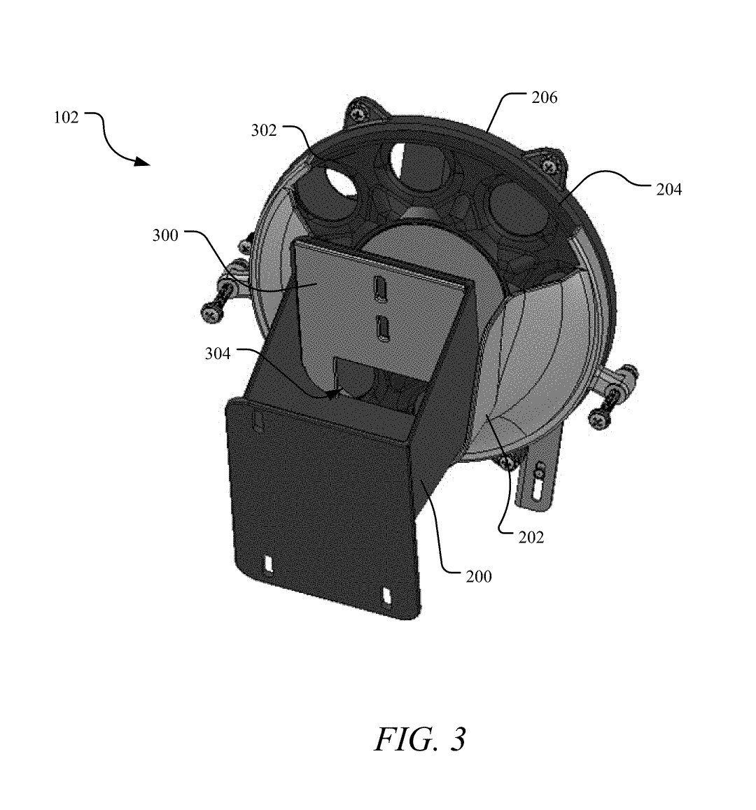

To facilitate capture of the coins by the wheel 204, the input bowl 202 is configured to position the coins in an upright orientation with an edge of the coin disposed upwards and a face of the coin disposed generally parallel and adjacent to a face 302 of the wheel 204. As can be understood from FIG. 3, in one implementation, the coin singulator 102 includes a partition 300 disposed in the input feeder 200 relative to the input bowl 202. The partition 300 includes a slot 304 sized to restrict a flow of coins from the input feeder 200 into the input bowl 202. More particularly, a batch of coins is received in the input feeder 200. The partition 300 prevents all the coins in the batch from moving from the input feeder 200 into the input bowl 202 at once. Instead, the coins are directed through the slot 304 in sub-batches into the input bowl 202 facilitating the positioning of the coins in the upright orientation for capture by the wheel 204.

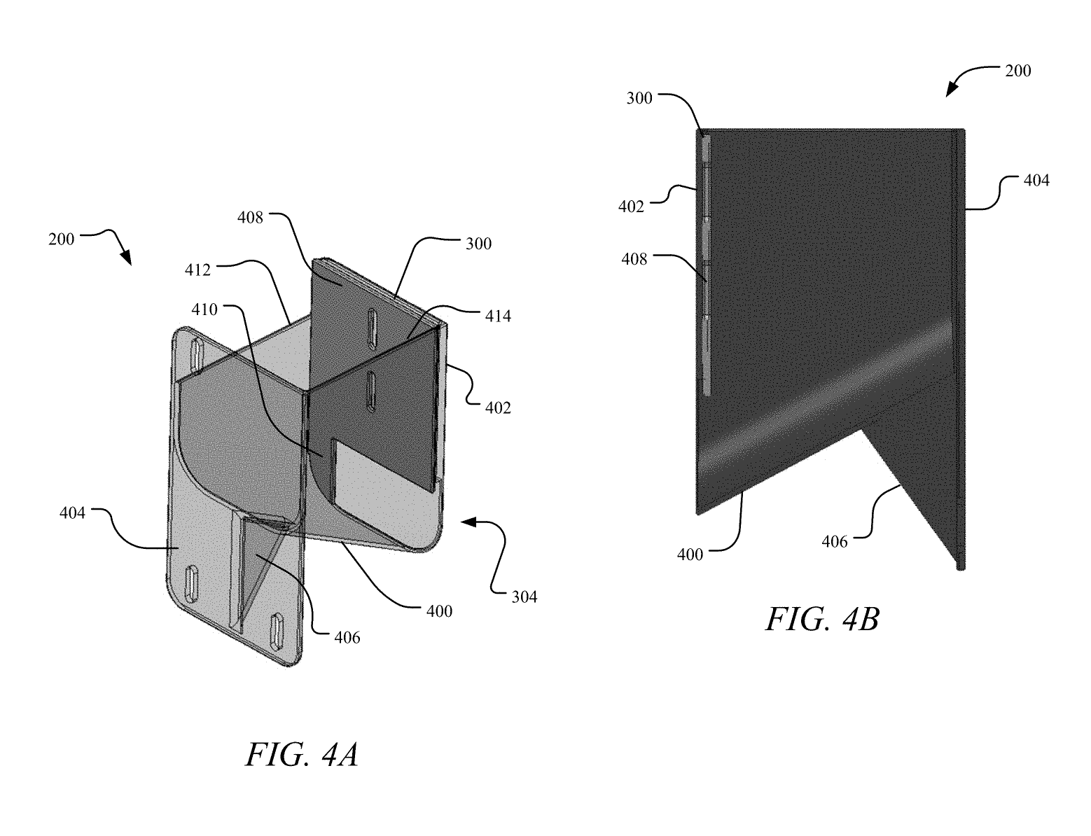

Referring to FIGS. 4A-4B, in one implementation, the input feeder 200 includes at least one input surface 400 extending between a first backing surface 402 and a second backing surface 404. The input surface 400 may further extend between a first edge 412 and a second edge 414 defining an opening into the input feeder 200 through which the batch of coins may be received. The input surface 400 may extend along one or more contours from the first edge 412 to the second edge 414. Alternatively or additionally, the input surface 400 may include a set of side surfaces each extending distally from the first edge 412 or the second edge 414 to a bottom surface. An input support 406 may be mounted to the input surface 400 and the second backing surface 404 to support a weight of the batch of coins.

In one implementation, the first backing surface 402 is disposed opposite the second backing surface 404. The input surface 400 may slope distally from the second backing surface 404 to the first backing surface 402. The first backing surface 402 may include the partition 300 or otherwise support the partition 300, such that the slope of the input surface 400 directs the coins with a restricted flow through the slot 304 in the partition 300. In one implementation, the partition 300 includes a partition surface 408 and one or more extensions 410 extending therefrom. A relationship of the partition surface 408, the one or more extensions 410, the first backing surface 402, and/or the input surface 400 may define a size and shape of the slot 304. For example, the first backing surface 402 may be integrated with or mirror a configuration of the partition surface 408 with the extension 410 extending distally to meet the input surface 400. In this case, the slot 304 is defined by an edge of the extension 410, a distal edge of the partition surface 408, and the input surface 400, as illustrated in FIG. 4A. The partition 300 may be removable and interchangeable to adjust the size and shape of the slot 304. Various configurations of the partition 300 may be used having different sizes and shapes of the partition surface 408, a plurality of the extensions 410, the extension 410 extending from a center of the partition surface 408, different widths of the extension(s) 410, and/or the like to adjust the flow of the coins from the input feeder 200 into the input bowl 202.

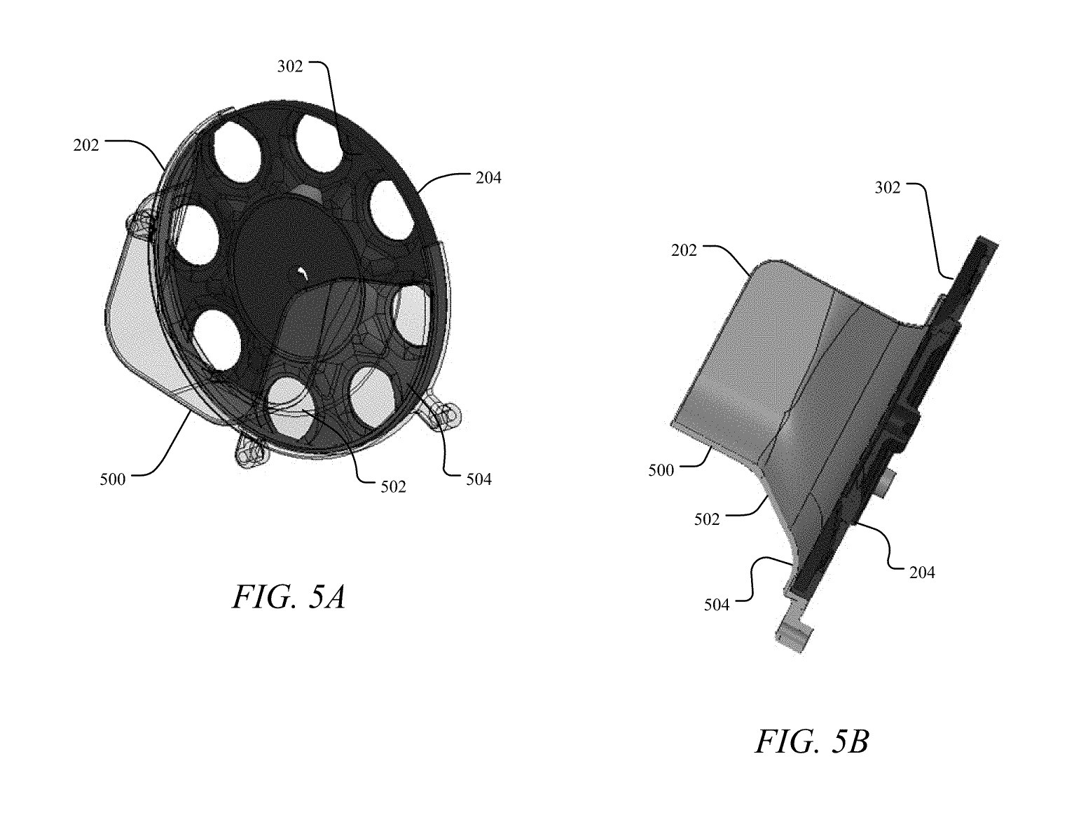

Turning to FIGS. 5A-5B, as described herein, the input bowl 202 includes a set of surfaces configured to position the coins in the upright orientation with a face of the coin disposed generally parallel and adjacent to the wheel face 302 for capture by the wheel 204. In one implementation, the input bowl 202 includes a first surface 500 that receives the coins from the input feeder 200 through the slot 304. The first surface 500 may shaped to mirror a shape of the input surface 400 to facilitate transport of the coins into the input bowl 202. In one implementation, the input surface 400 and the first surface 500 of the input bowl 202 overlap.

The first surface 500 may transition into a second surface 502 and a third surface 504 to move the coins into the upright orientation adjacent the wheel face 302. The second surface 502 may slope distally from the first surface 500 along a curve until reaching the third surface 504, which may curve into a plane generally parallel to the wheel face 302. In one implementation, each of the coins move in the input bowl 202 in a direction towards the wheel face 302 in a horizontal orientation with the coin face oriented generally parallel to the first surface 500 and generally perpendicularly to the wheel face 302. When the coin reaches the second surface 502, gravity pulls the coin along the second surface 502, and the coin transitions from the horizontal orientation until it reaches the third surface 504 where the coin is positioned in the upright orientation. Stated differently, in conjunction with gravity, the surfaces of the input bowl 202 are adapted to induce the coins to stand up against the wheel face 302 for capture by the wheel 204.

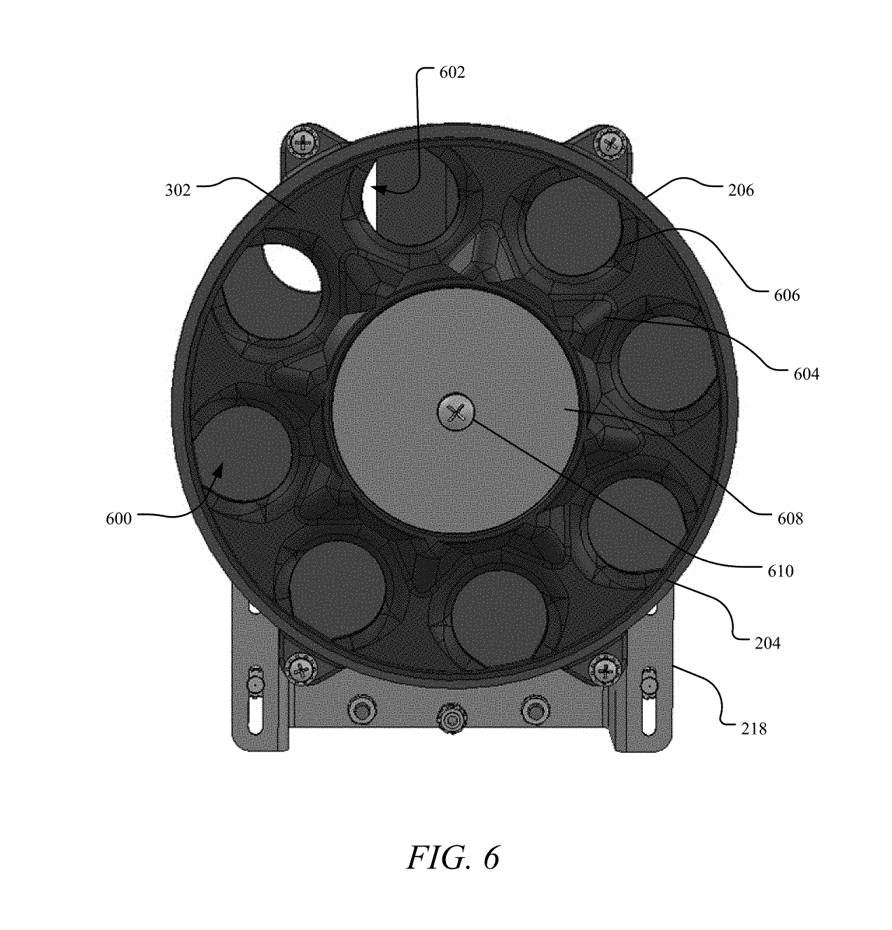

As can be understood from FIGS. 6-8, in one implementation, the wheel 204 includes a plurality of coin holes 600, each configured to capture a coin from the input bowl 202. Each of the coin holes 600 extends through the wheel 204. The coin holes 600 may be defined in the wheel 204 in various patterns. For example, the coin holes 600 may be arranged about the wheel 204 in an annular pattern spaced equidistant from each other. Additionally, while FIG. 6 illustrates eight coin holes 600, it will be appreciated that any number of coin holes 600 may be included.

The input bowl 202 positions the coins in the upright orientation against the wheel face 302. As the wheel 204 rotates, the coin holes 600 capture the coins in the upright orientation. In one implementation, the wheel 204 rotates against the wheel backing 206, which holds each of the coins in the coin holes 600 until the coins are separately directed through a coin exit 602.

In one implementation, each of the coin holes 600 are adapted to capture a single coin and direct any other coins back into the input bowl 202 for subsequent capture. For example, a contoured surface 606 may extend around each of the coin holes 600 to direct a single coin into the coin hole 606 and other coins away when the coin hole 600 is occupied. As described herein, the wheel 204 may be angled such that the input bowl 202 stands the coins in the upright orientation against the wheel face 302 using gravity. In the upright orientation, the coins are positioned for capture into the coin holes 600 one at a time. When the wheel 204 spins, the individual coins are separately captured into each coin hole 600 while other coins slide off of the contoured surface 606 and back into the pile of coins. One or more guards 604 may protrude from the wheel face 302 about a center of the wheel 204 to prevent the coins from sliding out of the coin holes 600 while the wheel 204 rotates. The coin travels in the coin hole 600 as the wheel 204 spins until reaching the coin exit 602, where the coin separately falls through the coin hole 600 and the coin exit 602. Stated differently, a relationship of the wheel 204 and the wheel backing 206 isolates the coins, such that one coin at a time is transitioned from the corresponding coin hole 600 through the coin exit 602 and onto a coin rail 700 using gravity.

In one implementation, the coin rail 700 is defined in a proximal section of the wheel backing 206 adjacent the coin exit 602. The coin is directed onto the coin rail 700 using gravity, where the coin remains in the upright orientation, such that it rolls on its edge along the coin rail 700 towards the discriminator 104. The coin rolls along the coin rail 700 with an initial speed related to a rotation speed of the wheel 204.

The wheel 204 is rotated using a motor assembly 716. In one implementation, the motor assembly 716 includes the motor 220, the motor bracket 218, the encoder 212, a belt 704, a drive shaft 706, a sensor bracket 708, an encoder sensor 710, a first pulley 712, and a second pulley 714. The motor 220 is mounted to the motor bracket 218, which connects to the back plate 208. The motor 220 drives the first pulley 712, which drives the belt 704. The belt 704 in turn drives the second pulley 714. The second pulley 714 drives the drive shaft 706, which turns the wheel 204. The drive shaft 706 extends through the wheel 204, the wheel backer 206, a wheel top plate 608, and the back plate 208. A center bolt 610 may be mounted into the drive shaft 706 to lock the components together. The encoder sensor 710 is mounted on the sensor bracket 708, which is attached to the wheel backer 206. The encoder 212 may be mounted on the second pulley 714. The encoder 212 is configured to control the rotation speed of the wheel 204, which dictates the coin throughput rate and the initial speed of the coin output onto the coin rail 700 and traveling toward the discriminator 104 for analysis.

Various operations and calculations performed by the discriminator 104 may depend on the initial speed of the coin and therefore the rotation speed of the wheel 204. For example, the discriminator 104 may be calibrated based on a predetermined range of coin speeds including a minimum coin speed and a maximum speed. The minimum coin speed may correspond to a speed at which the coin will continue to roll along the coin rail 700 to the discriminator 104 under the force of gravity without stopping. On the other hand, the maximum coin speed may depend on a number of factors, including, without limitation, a gap between the coins as they travel through the discriminator 104, pulse width values for measuring the coins, and the like. More particularly, a minimal gap between coins may cause one or more of the sensors in the discriminator 104 to miss an edge of the coins, for example due to signal debouncing and finite sensor rise times. Additionally, a signal/noise ratio of the diameter measurements of coins may decrease as pulse widths narrow, which increases the variability in diameter measurements for coins that are travelling quickly or have a smaller diameter. A minimal gap may further result in two coins touching as they pass through the discriminator 104, resulting in coin size measurements which are excessively large, along with an incorrect count of the number of coins sorted. In some cases, a rapid presentation of coins to the discriminator 104 may result in an excessively small measurement, for example due to debounce issues. Thus, the encoder 212 may control the rotational speed of the wheel 204 to transfer the coin to the coin rail 700 at an initial speed between the maximum speed and the minimum speed.

As described herein, the encoder 212 may further servo the rotational speed of the wheel 204 to maintain a specified throughput rate. For example, the encoder 212 may adjust the rotational speed of the wheel 204 to account for various circumstances (e.g., capturing fewer coins in the coin holes 600, jams, etc.) to achieve a throughput rate of approximately 240 coins per minute for each batch of coins, subject to the maximum rotation speed described above. With this throughput rate, if 100% of the coin holes 600 capture coins when singulating, the wheel 204 will be rotated at approximately 30 rpm where the wheel 204 includes eight coin holes 600 (30 rpm*8 coins/rotation=240 coins per minute (cpm)). Since the capture rate of coins will not always be 100%, a given coin may be placed onto the coin rail 700 with the wheel 204 rotating faster than 30 rpm in order to come as close as possible, but not exceed, 240 cpm for the batch of coins.

Along with other features of the coin singulator 102 adapted to reduce and address coin jams, such as a jam resistor groove 702 defined in the wheel backing 206 and the floating arrangement of the input bowl 202, the encoder 212 may operate the wheel 204 to handle different types of coin jams. One type of jam may occur when coins stop somewhere along the coin rail 700, and stack back up toward the input bowl 202 and/or input feeder 200. The encoder 212 may detect this type of jam by identifying a constant ON value for any of the sensors in the discriminator 104. For this scenario, the encoder 212 may stop the rotation of the wheel 204, retract the ejectors of the coin sorter 106, and output an alert to a user interface for manual intervention.

Another type of jam occurs when coins get “stuck,” preventing the wheel 204 from rotating. The encoder 212 may detect such a jam by monitoring the current to the motor 210. For this scenario, the wheel 204 may be rotated in reverse slightly followed by resumed forward rotational motion. If successive attempts (e.g., reversing the motion each time or continuing in the reverse direction) to break this type of jam are unsuccessful, the encoder 212 may halt operation and output an alert to the user interface.

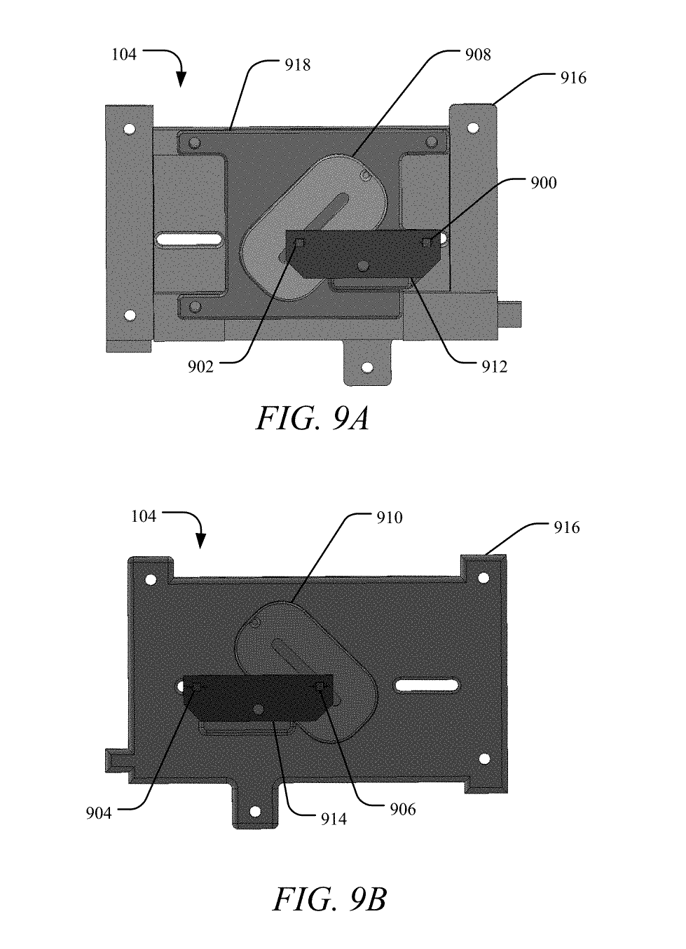

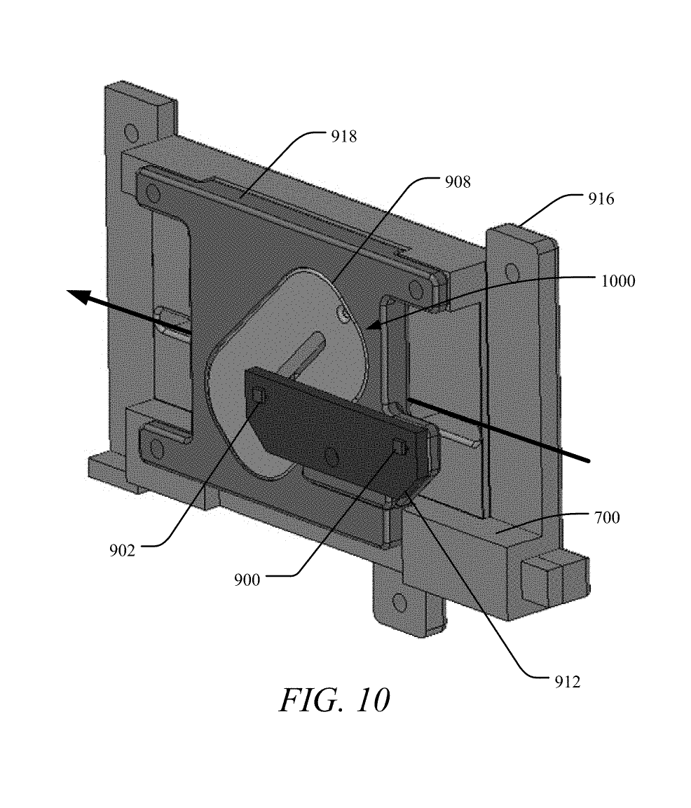

To begin a detailed description of the discriminator 104, reference is first made to FIGS. 9A-10. The discriminator 104 includes one or more sensors configured to determine a coin type, such as a denomination and/or validity, by determining one or more features of the coin, such as size, material composition, and/or the like. In one implementation, the one or more sensors include a set of sensors having one or more optical sensors and a set of inductors having one or more coils, such as a primary coil and a secondary coil. The set of optical sensors may be arranged in various configurations, including, but not limited to, a vertical alignment, a horizontal alignment, or the like, relative to the coin face as it travels along the coin rail 700. The set of inductors may similarly be arranged in various configurations to permit measurements of the coin while the coin is disposed between the set of inductors.

In one implementation, the discriminator 104 includes a first optical sensor 900 and a second optical sensor 902 housed in a first PCB sensor 912. The first PCB sensor 912 and a first inductor 908 may be mounted on a front plate 918. A first emitter 904 and a second emitter 906 may be housed in a second PCB sensor 914, with the second PCB sensor 914 and a second inductor 910 mounted on a back plate 916. The front plate 918 is disposed relative to and connected to the back plate 916.

As shown in FIG. 10, a coin travels along the coin rail 700 at a speed dictated by the rotational speed of the wheel 204 through the discriminator 104 as indicated by the black arrow. In one implementation, the coin passes the first optical sensor 900 and the first emitter 904, before passing between a set of inductors 1000 including the first inductor 908 and the second inductor 910. Before exiting the set of inductors 1000, the coin passes between the second optical sensor 902 and the second emitter 906.

As described in more detail below, in one implementation, the optical sensors 900 and 902 are configured to capture signals generated by the first emitter 904 and/or the second emitter 906 from which a diameter of the coin may be calculated. Further, the optical sensors 900 and 902 may be used to determine when the coin is positioned along the coin rail between the set of inductors 1000, which generates one or more signals at this time. Because electromagnetic energy passes through various metals differently, the mutual inductance between the first inductor 908 and the second inductor 910 is affected differently by each coin type. In one implementation, the response of the signal is measured at the set of inductors 1000 for a plurality of frequencies measured when the coin is located between the set of inductors 1000.

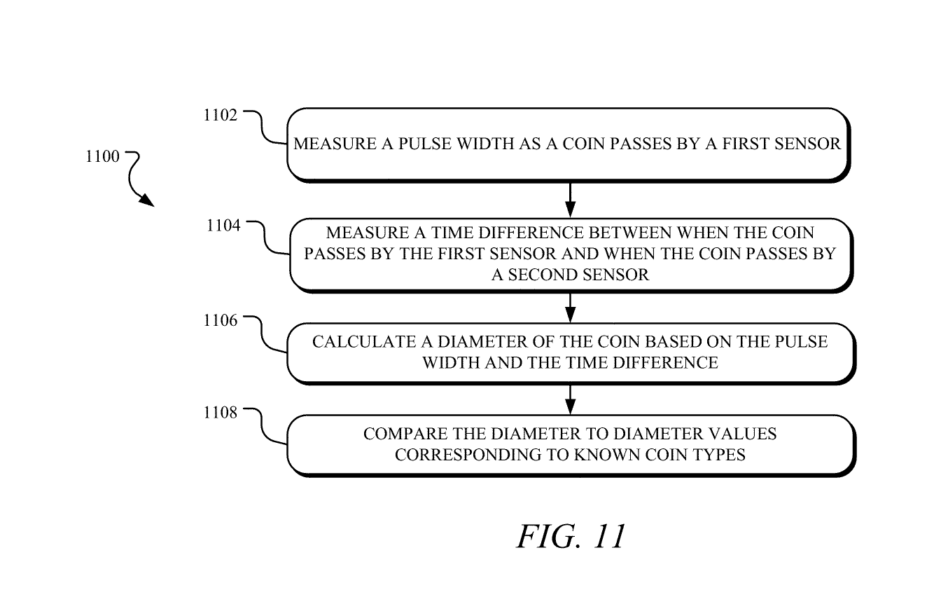

Turning to FIG. 11, example operations 1100 for determining a coin diameter are shown. In one implementation, an operation 1102 measures a pulse width as a coin passes by a first sensor, such as a first optical sensor. The pulse width may correspond to a time the coin remains detected by the first sensor. An operation 1104 measures a time difference between when the coin passes by the first sensor and when the coin passes by a second sensor, such as a second optical sensor. Depending on whether the first sensor and the second sensor are arranged in a vertical alignment or a horizontal alignment, the operations 1102 and/or 1104 may use a leading and a trailing edge of the coin or a chord of the coin in conducting the measurements. An operation 1106 then calculates a diameter of the coin accordingly.

In one implementation, the first and second sensors are arranged in a vertical alignment generally parallel to a face of the coin as it travels along the coin rail. Here, the operations 1102 and/or 1104 detect the leading and trailing edges of the coin as it moves along the coin rail. The operation 1106 determines a first-order approximation to a speed of the coin by using the pulse width of the first sensor measured in the operation 1102, and the time between the leading edge of the pulse at the first sensor and the leading edge of the pulse at the second sensor measured in the operation 1104. The operation 1106 uses the speed of the coin and a known distance between the first sensor and the second sensor to calculate a diameter of the coin.

For example, if the distance between the first sensor and the second sensor is 36.75 mm, and the pulse width (APULSEWIDTH) measured in the operation 1102 has a value of 60 msec, and time difference (ATOBTIME) measured in the operation 1104 has a value of 90 msec, then the operation 1106 calculates the coin diameter as:

Dia=36.75 mm*APULSEWIDTH/ATOBTIME (Equation 1)

Dia=36.75*60/90 mm=24.5 mm

It will be appreciated that friction, gravity, and other nonlinearities may be accounted for by modifying the above equation based on empirically-derived data. For example, when the diameter of a coin is calculated using the linearized model of Equation 1, its velocity at the first sensor (Opto A) affects the accuracy of the calculation by the operation 1106. To show this effect, consider the equation which describes velocities (for motion under constant acceleration):

v_{f}²−vᵢ²=2 a s (A1)

In Equation A1, v_{f} is the final velocity of the coin at the second sensor (Opto B), and vᵢ is the velocity of the coin when its leading edge triggers Opto A. Variable s is the distance travelled. As described in the example above, the effective distance between Optos A and B is 36.75 mm. Finally, a is the value of the coin's acceleration.

If the coin rail is tilted approximately 23 degrees from the horizontal,

a=ĝ sin(23π/180) (A2)

In Equation A2, ĝ is acceleration due to gravity. This equation ignores friction and other higher-order effects. Inserting values into Equation A2 yields the following acceleration value for the coins:

a=3.82(m/s2) (A3)

The right-hand side of Equation A1, which is related to the change in velocity of the coins between Optos A and B, is independent of the initial coin speed. The right-hand side of Equation A1 is computed to be 0.281 m2/s2, as follows:

2 a s=2*3.82(m/s2)*0.03675(m) (A4)

2 a s=0.281(m2/s2) (A5)

Now consider two cases: a coin placed onto the coin rail at nominal speed, and a coin placed onto the rail at a speed half of nominal speed.

Case 1: Coin placed onto the rail at nominal speed. A typical AtoBTime may be, for example, between 50 and 60 ms. If the coin is rolling with an AtoBTime of 57 ms, the average velocity of the coin would be 36.75 mm/57 ms, or 0.64 m/s, with 0.64 m/s set as the nominal velocity in this example. For case 1, set the initial coin velocity to the nominal velocity:

vᵢ=0.64 m/s (A6)

Inserting values into Equation A1 and solving for v_{f} results in

v_{f}=0.83 m/s (A7)

Here, the change in velocity for Case 1 is 0.19 m/s, or a percentage change of 29%.

Case 2: Coin placed onto the rail at half of nominal speed. For case 2, set the initial coin velocity to half of the nominal velocity:

vᵢ=0.32 m/s (A8)

Inserting values into Equation A1 and solving for v_{f} results in

v_{f}=0.62 m/s (A9)

Here, the change in velocity for Case 2 is 0.30 m/s, or a percentage change of 93%.

The absolute change in velocity differs for the two cases above: 0.19 m/s for the faster coin vs. 0.30 m/s for the slower coin. In addition, the percent change is only 29% for the faster coin, but 93% for the slower coin. Therefore, the speed of the faster coin when it is at Opto A is closer to the average speed of the coin between Optos A and B than that of the slower coin. In other words, the APulseWidth value for the slower coin will be larger than expected when the assumptions of Equation 1 are used.

By collecting empirical data for coins of known sizes, the operations 1102 and/or 1104 may be modified to account for nonlinear effects. For example:

Dia=38.717*APULSEWIDTH/ATOBETIME−0.0145*ATOBETIME+0.417

A different design for A and B locations resulted in empirical corrections to yield the following equation for coin diameter:

Dia=30.800*(APULSEWIDTH+3.780)/ATOBETIME+0.023*APULSEWIDTH−4.103

In another implementation, the first and second sensors are arranged in a horizontal alignment generally perpendicular to the face of the coin as it travels along the coin rail. Here, the operations 1102 and/or 1104 no longer detect the leading and trailing edges. Instead, the height of the first and second sensors above the coin rail determines the chord, which will be seen by the sensor. In addition to the empirical corrections for friction, gravity, and other nonlinearities described above, the operation 1106 may make a correction to determine the diameter of the coin when only a chord of the shape of the coin is detected by the first and second sensors in the operations 1102 and 1104.

For example, if the first and second sensors are located h mm above the coin rail, the operation 1106 calculates the chord length passing by the sensors compared with the actual coin diameter geometrically as:

Cord=2*SQRT[h*(dia−h)] where dia is the diameter of the coin.

The effect of this chord versus diameter measurement can be inverted to determine the diameter of the coin given APULSEWIDTH and ATOBTIME measurements. When the radius of the coin is greater than the height of the sensors, the calculated diameter will be too small. The height of the first and second sensors can be set based on the various diameters of coins to be discriminated to optimize the detection capabilities. Inversion of the equation for chord versus diameter can be accomplished algebraically and/or empirically.

In one implementation, an operation 1108 compares the diameter determined using the operation 1106 to diameter values corresponding to known coin types. The diameter values may be stored, for example, in a table, a model, or the like. The diameter values may be programmed into the coin recycling system 100 using a user interface of the coin recycling system 100, using a computing device in communication with the coin recycling system 100, obtained empirically by the coin recycling system 100, and/or the like.

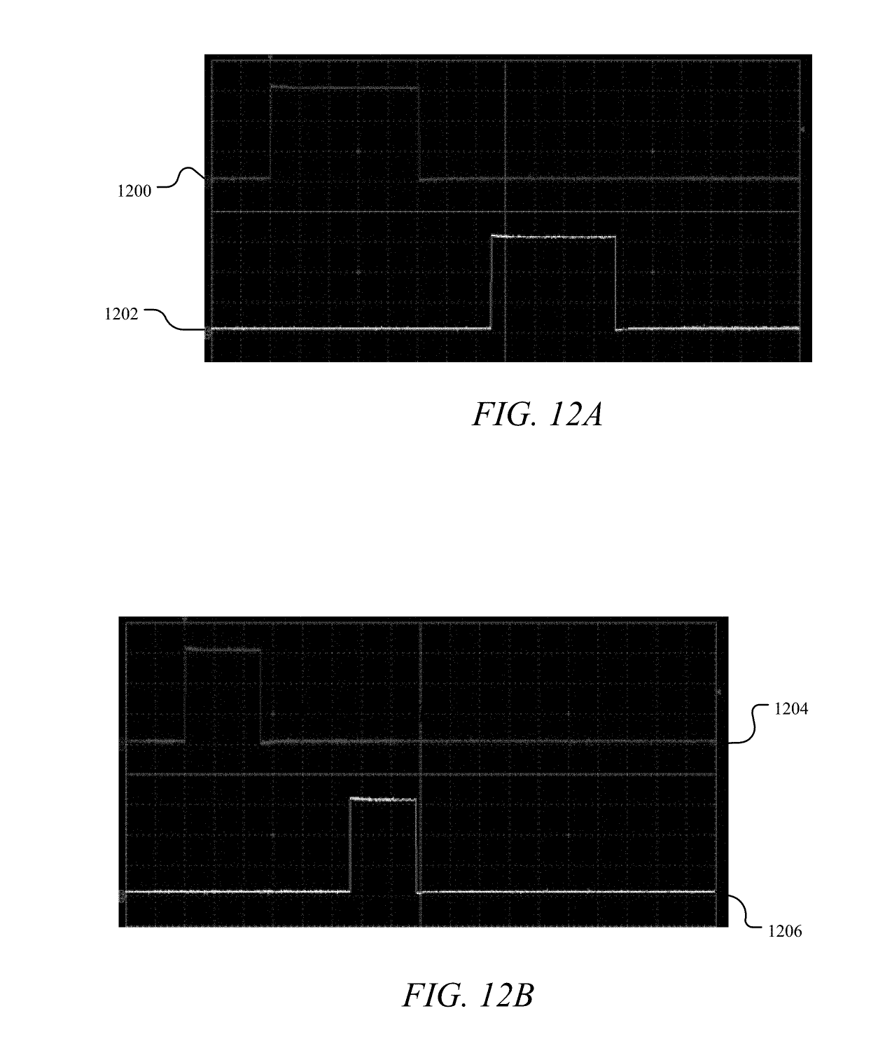

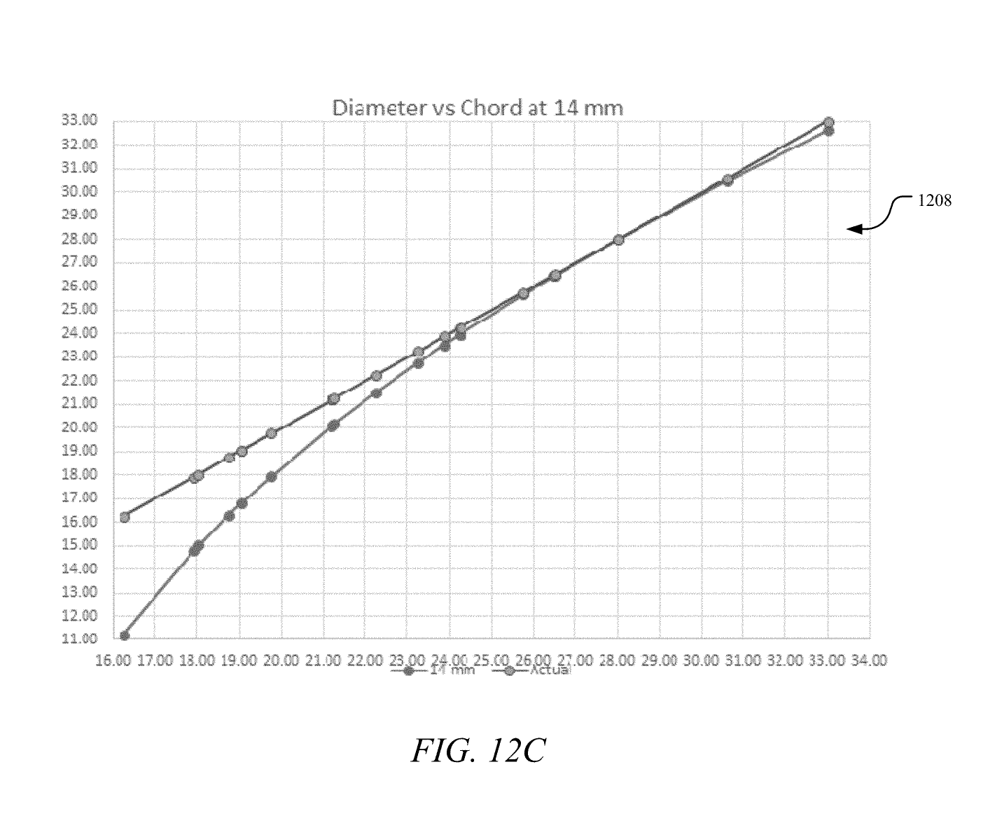

Turning to FIGS. 12A-12B, signals obtained from the first optical sensor 900 and the second optical sensor 902 for a first coin type and a second coin type, respectively, are shown. A first response 1200 for the first coin type is obtained from the first optical sensor 900 and a second response 1202 is obtained for the first coin type from the second optical sensor 902, as shown in FIG. 12A. The pulse width and the time difference are measured from these responses 1200-1202. Similarly, as shown in FIG. 12B, a first response 1204 is obtained from the first optical sensor 900 for the second coin type, and a second response 1206 is obtained from the second optical sensor 902 for the second coin type, which are used to measure the pulse width and the time difference for the second coin type. The differences in the signals between FIGS. 12A and 12B illustrate the differences for various coin sizes.

FIG. 12C is a graph showing a relationship 1208 between a diameter of a coin verses a chord of the coin, which may be used where the first and second sensors 900, 902 are arranged in a horizontal alignment.

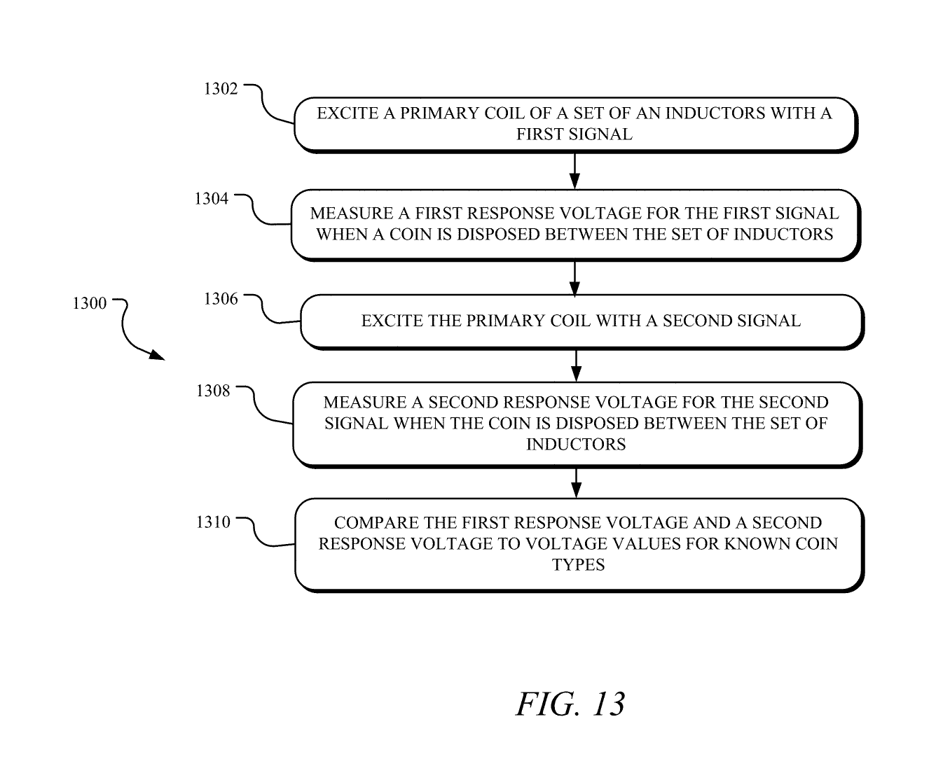

Turning to FIG. 13, example operations 1300 for determining a coin denomination are shown. In one implementation, an operation 1302 excites a primary coil of a set of inductors with a first signal, and an operation 1304 measures a first response voltage for the first signal when a coin is disposed between the set of inductors. An operation 1306 excites the primary coil with a second signal, and an operation 1308 measures a second response voltage for the second signal when the coin is disposed between the set of inductors. The second signal is a different frequency than the first signal, and the operations 1304 and 1308 may measure the response voltages from a secondary coil in the set of inductors. In one implementation, an operation 1310 compares the response voltages determined using the operations 1304 and 1308 to voltage values corresponding to known coin types. The voltage values may be stored, for example, in a table, a model, or the like. The voltage values may be programmed into the coin recycling system 100 using a user interface of the coin recycling system 100, using a computing device in communication with the coin recycling system 100, obtained empirically by the coin recycling system 100, and/or the like. The operations 1100 may be performed in conjunction with or separate from the operations 1300.

In one implementation, the operations 1302-1308 measure the response of the signal at the inductors for two different frequencies, both of them measured when the coin is substantially fully located between the inductors in measurement position. In the case of a first sensor and a second sensor in a vertical alignment, the second sensor may be located so that it detects the leading edge of the coin when that coin is fully between the inductors. It is at that moment that the operation 1304 records the result from signal of the operation 1302, and immediately switches to the signal of the operation 1306. The operation 1308 records the result. In the case of the first sensor and the second sensor in a horizontal alignment, an operation calculates when the coin will be at location in the measurement position and conduct the measurements through the operations 1302-1308 at that time.

In another implementation, the operations 1300 utilize voltage data to determine when the coin is at the proper location relative to the inductors in the measurement position. The operations 1302 and 1306 begin switching between the first signal and the second signal (having different frequencies) after a configurable delay from when the coin is detected at the second sensor. The operations 1304 and 1308 measure the response voltage for each period of time for the first signal and the second signal, and use one of the frequencies to determine when those values are at a minimum. This occurs when the coin is most fully between the two inductors in the measurement position. The operations 1304 and 1308 record the response for the first signal and, for the following pulse event, the response for the second signal, for the coin.

Stated differently, the operation 1302 and the operation 1306 excite the primary coil of the set of inductors with pulses alternating between the first signal and the second signal. The operations 1304 and 1308 record a history of response voltages from the secondary coil for both the first signal and the second signal as the coin passes between the set of inductors. The operations 1304 and 1308 determine minimum response voltages from the secondary coil for either the first signal and/or the second signal corresponding to the coin being between the set of inductors. The operations 1304 and 1308 identify the measured response to the first signal and to the second signal based on the identified pulses for which the coin was between the set of inductors.

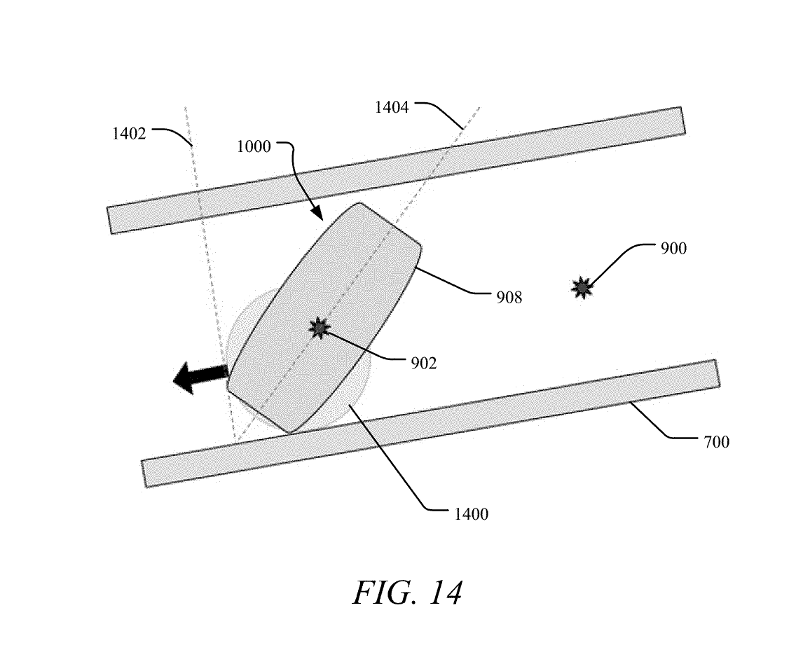

Turning to FIG. 14, in one implementation, as described above, when a coin 1400 is not present a first signal is applied across the set of inductors 1000. As the coin 1400 rolls on the coin rail 700 and begins passing through the set of inductors 1000, the response voltage for the first signal is measured and recorded. When the leading edge of the coin is expected to reach an exit of the set of inductors 1000, shown as a dotted line 1402, a second signal is applied across the set of inductors 1000 and the response voltage for the second signal is measured and recorded. When the trailing edge of the coin 1400 crosses the second optical sensor 902, the second signal reverts back to the first signal.

In one implementation, the set of inductors 1000 is rotated by 45 degrees relative to the coin rail 700. This orientation of the set of inductors 1000 provides that the coin 1400 will be approximately centered across a short axis of the set of inductors, shown as dotted line 1404, when the coin 1400 reaches the exit 1402, regardless of the diameter of the coin 1400, thereby providing consistent measurements.

In one particular example implementation, when there is no coin present at the second optical sensor 902, a 24 kHz square wave, switching between 0 and 4.75 V at a 50% duty cycle, is applied across the leads of one of the inductors 1000 (e.g., the first inductor 908). The response signal is measured across the leads of the other inductor (e.g., the second inductor 910). When the second optical sensor 902 detects the presence of the coin 1400, the input signal to the inductor 908 is changed to 9 kHz. This signal reverts to 24 kHz when the trailing edge of the coin 1400 passes the second optical sensor 902. The output signal from the discriminator 104 may be passed to a Waveform Shaper circuit, which has peak hold and signal smoothing functions. As described herein, three measurements are taken for the coin 1400: (1) the peak voltage response to a 24 kHz square wave input, during a period when no coin is present, (2) the peak voltage response to a 24 kHz square wave input, just prior to a leading edge of the coin 1400 being at the second optical sensor 902, and (3) the peak voltage response to a 9 kHz square wave input, just after the leading edge of the coin 1400 is at the second optical sensor 902.

When no coin is inside the discriminator 104, the voltage of the peaks remains constant. Peaks in the output signal are the response of the inductors 1000 to the 24 kHz input signal. The value of these peaks is used to determine the instantaneous calibration setting for the discriminator 104, VCal, as follows:

VCal=VCalMax/Cal_Constant, where VCalMax is the measured peak value described above (with no coin between the inductors 1000), and Cal_Constant is the nominal value for this voltage peak. In one particular example, Cal_Constant is set to 1.230 V. This method of conducting a quick calibration before assessing each coin makes the system 100 robust to voltage and temperature fluctuations over time.

The peak values of the output signal lower as the coin 1400 enters the discriminator 104. During this period the signal frequency remains 24 kHz, and some of the magnetic energy of the mutual inductors 1000 is absorbed by the coin 1400. This absorption amount varies by coin.

When the second optical sensor 902 senses the coin 1400, the frequency of the signal to the inductor 908 is reduced to 9 kHz. That change affects the energy absorption of the coin 1400, resulting in the nearly stepwise increase in voltage seen immediately after the trigger event occurs.

The discriminator 104 evaluates the peak values just before the change in frequency (V24kMax) and just after the change in frequency (V9kMax). These values are multiplied by VCal, and compared to the table of values for known coin types, as in the following equations, for example:

V09k=VCal*V9kMax

V24k=VCal*V24kMax

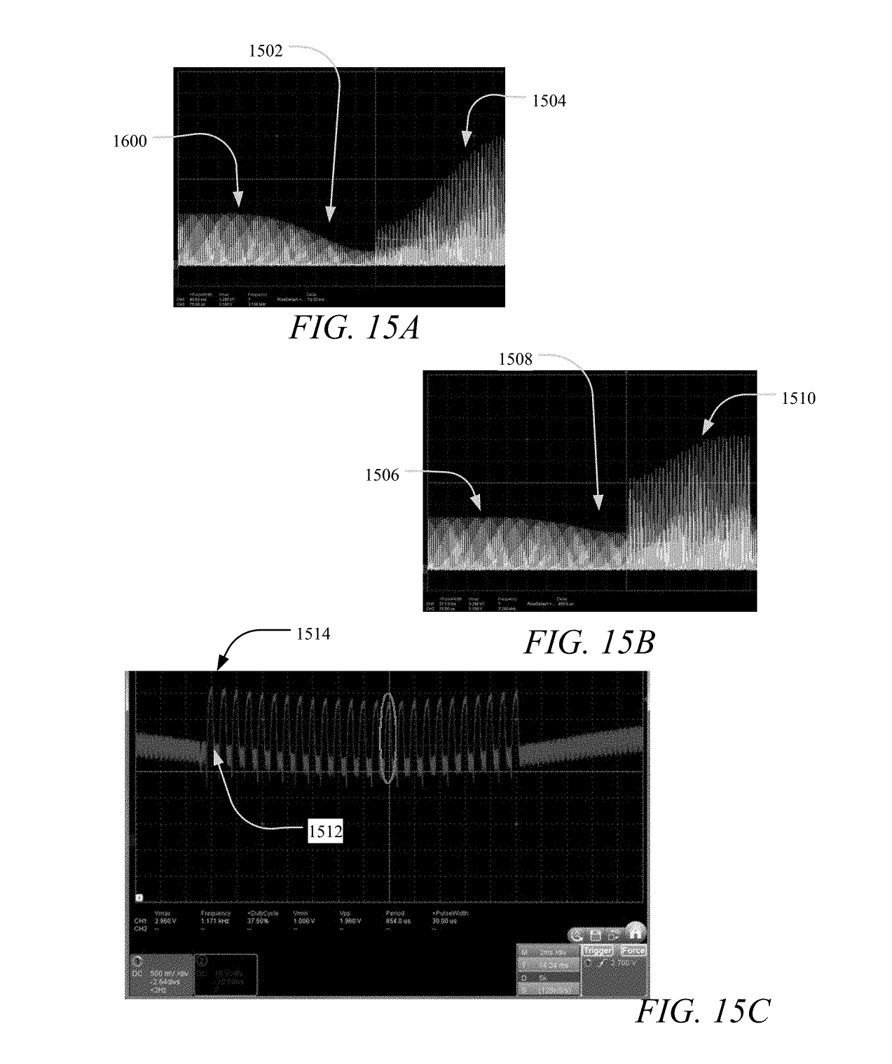

As the coin continues through the inductors 1000, the energy absorbed by the coin 1400 reduces. This accounts for the rising envelope of the output signal. At some point the trailing edge of the coin 1400 passes the second optical sensor 902, which triggers the discriminator 104 to revert the signal back to the original 24 kHz square wave in preparation for the next coin. Examples of output signals for a coin are shown in FIGS. 15A-15B.

FIGS. 15A-B show example responses to the set of inductors 1000 and the two signal responses for a first coin type and a second coin type, respectively. In one implementation, a first portion 1500, 1506 of the wave response is the respective response for the first signal when no coin is present; a second portion 1502, 1508 is the respective response for the first signal when a coin is present; and a third portion 1504, 1510 is the respective response for the second signal when the leading edge of the coin is at the second optical sensor 902. In the first portion 1500, 1506, the response is flat, as there is no object present to change the absorption rate of the magnetic energy generated from the set of inductors 1000. In the second portion 1502, 1508, the signal decreases as the coin absorbs some of the magnetic energy of the set of inductors 1000. The absorption amount varies based on the material makeup of the coin. For example, the energy absorbed by the first coin type in the second portion 1502 shown in FIG. 15A is less than the energy absorbed by the second coin type in the second portion 1508 shown in FIG. 15B.

Continuing through the response signal from left to right, the step increase indicates that the first signal was changed to the second signal. Again, the energy absorbed is different based on the material makeup of the coin and in this case the first coin type absorbs less energy than the second coin type. The rise in the response of the third portion 1504, 1510 indicates that the coin is exiting the set of inductors 1000 and hence less energy is absorbed. The peak value for the response for the first signal and the second signal are recorded during this process.

FIG. 15C illustrates example voltage responses where the first inductor is excited with pulses alternating between the first signal frequency and the second signal frequency, as detailed above. A response 1512 to the first signal and a response 1514 to the second signal are shown in FIG. 15C, along with minimum values shown in the circle.

When the values corresponding to coin diameter, response for the first signal peak value, and response for the second signal peak value are recorded, the values are compared to known values stored in firmware of the discriminator 104. The values can be predetermined before being stored or can be learned directly by the discriminator 104. The discriminator 104 determines if the measured values match a set of known values for a particular coin type. If the discriminator 104 does not find a match in the known values, then the coin is rejected as non-compliant via a rejection chute. If the discriminator 104 finds a match in the known values, then the discriminator 104 designates which chute the coin should be sorted into for storage and/or subsequent use.

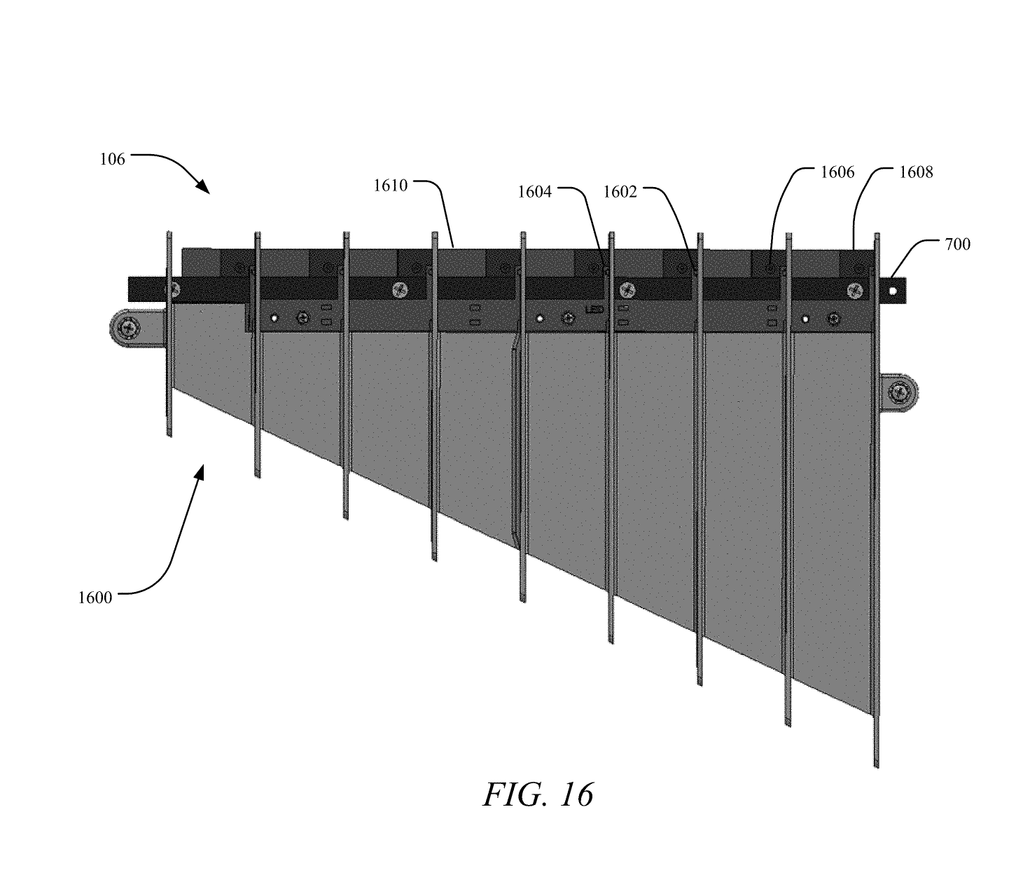

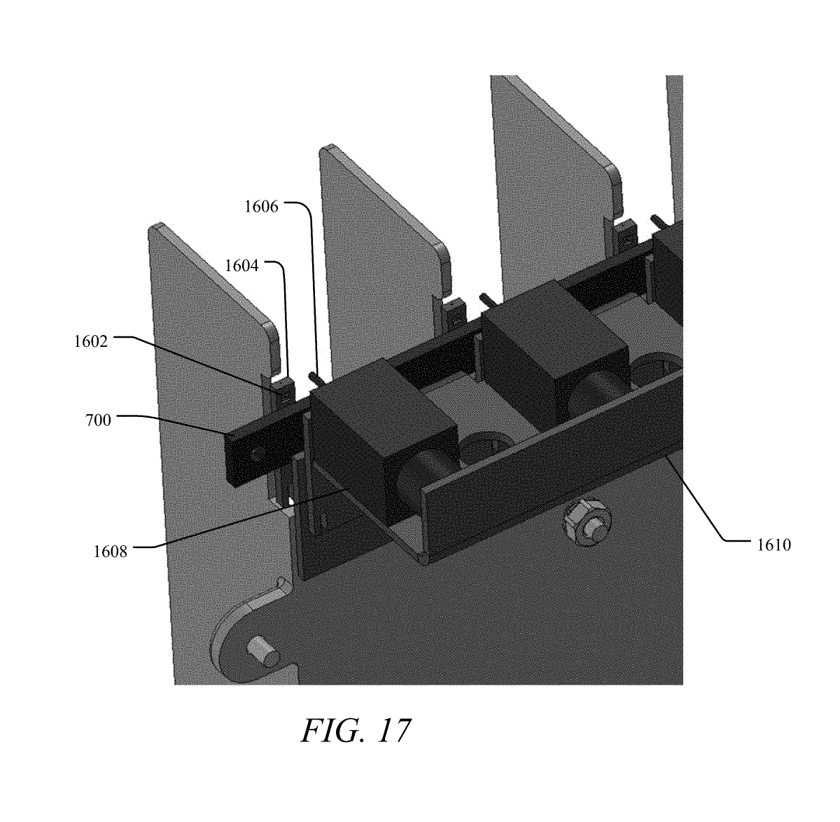

Referring to FIGS. 16-17, after the denomination, validity, and/or other coin type characteristics of the coin are determined by the discriminator 104, the coin is directed along the coin rail 700 to the coin sorter 106 for ejection into a chute designated by the discriminator 104 and corresponding to the coin type.

In one implementation, the coin sorter 106 includes a plurality of chutes 1600, a plurality of optical sensors 1602, a sensor rack 1604, a plurality of solenoids 1608, a plurality of solenoid plungers 1606, and a solenoid bracket 1610. The plurality of solenoids 1608 are attached to the solenoid bracket 1610, which may be attached to the back plate 208. The plurality of optical sensors 1602 are attached to a sensor rack 1604, which also may be attached to the back plate 208.

When a coin is matched to one of the plurality of chutes 1600 by the discriminator 104, the coin travels on the coin rail 700 until it reaches its designated chute 1600. Before any coin is present, the plurality of solenoid plungers 1606 are retracted into the plurality of solenoids 1608. When the optical sensor 1602 at the designated chute 1600 senses the coin, the sensor 1602 signals the solenoid 1608 to push the solenoid plunger 1606 towards the coin, such that it will push the coin into the chute 1600.

In one implementation, where there is a match between a coin and an entry in the coin table of values corresponding to known coin types, the discriminator 104 schedules that coin to be ejected into its proper chute. To support this functionality, the records in the coin table may contain additional parameters, including but not limited to: which chute to use, indexed from 0 at the top to n (e.g., 7) at the bottom; a delay, in ms, between when the chute coin sensor 1602 detects the coin and when the knock-off solenoid 1608 is actuated; and an amount of time, in ms, to keep the solenoid plunger 1606 extended before signaling it to retract.

If the coin is a non-compliant coin, then the coin will continue down and exit the coin rail 700 into a rejected coins pile. It will be appreciated that this implementation of the coin sorter 106 is one possible example with other configurations of ejectors being contemplated.

The coin recycling system 100 can be configured such that any coin can be sorted into any hopper by simply changing the values of known coin types and corresponding chutes 1600. This allows a user to fully customize the order and denomination for each chute 1600. For example, a table of known values can be configured so that a US penny is sorted into every other chute and a US dime is sorted into the chutes in between the US pennies. This allows coins to be sorted into completely customized combinations. The combinations can also be easily changed by simply uploading a new coin table to the firmware. The coin recycling system 100 allows users to quickly and efficiently sort coins into any desirable combination and to instantly change the combination as needed.

Generally, the coin recycling system 100 includes functionality to process batches of coins. This includes the features needed in order to configure the coin recycling system 100 for different currencies, diameter and voltage values, and sortation schema. It also includes the mechanics of coordinating the batch, from starting the wheel 204 on demand, to serving the wheel speed, to counting numbers and values of discriminated coins, to ejecting the coins properly into their respective hoppers, to knowing how many unknown items were placed onto the coin rail 700, to stopping the wheel 204 when a coin has not been detected for a certain amount of time (e.g., 5 seconds), and, finally, to reporting the coin counts and values sorted for each batch.

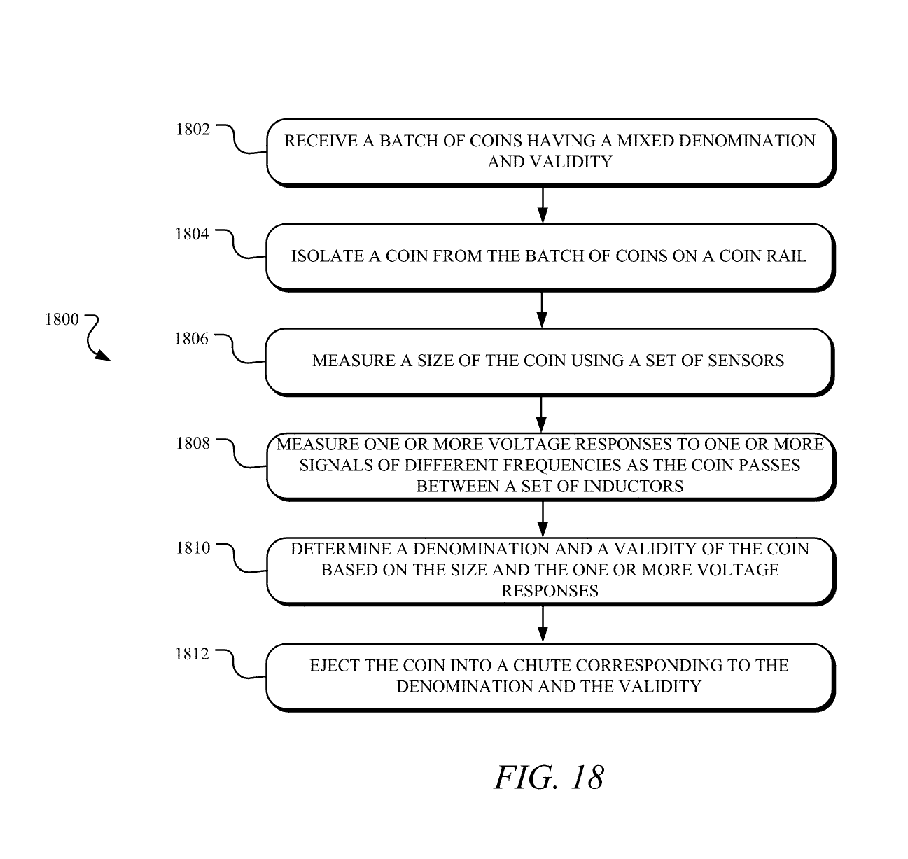

FIG. 18 shows example operations 1800 for sorting a batch of coins into customizable combinations. In one implementation, an operation 1802 receives a batch of coins having a mixed denomination and/or validity. An operation 1804 isolates a single coin from the batch of coins on a coin rail, and an operation 1806 measures a size of the coin using a set of sensors, such as a set of optical sensors. An operation 1808 measures one or more voltage responses to one or more signals of different frequencies as the coin passes between a set of inductors. An operation 1810 determines a denomination and a validity of the coin based on the size and the one or more voltage responses, and an operation 1812 ejects the coin into a chute corresponding to the denomination and validity.

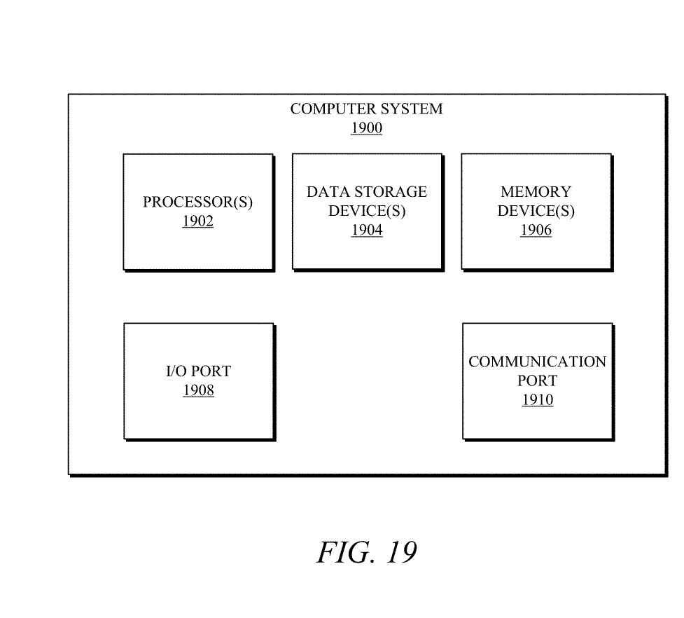

Referring to FIG. 19, a detailed description of an example computing system 1900 having one or more computing units that may implement various systems and methods discussed herein is provided. The computing system 1900 may be applicable to the encoder 212, the discriminator 104, and/or other computing or network devices part of or otherwise in communication with the coin recycling system 100. It will be appreciated that specific implementations of these devices may be of differing possible specific computing architectures not all of which are specifically discussed herein but will be understood by those of ordinary skill in the art.

The computer system 1900 may be a computing system is capable of executing a computer program product to execute a computer process. Data and program files may be input to the computer system 1900, which reads the files and executes the programs therein. Some of the elements of the computer system 1900 are shown in FIG. 19, including one or more hardware processors 1902, one or more data storage devices 1904, one or more memory devices 1908 (e.g., firmware of the discriminator 104), and/or one or more ports 1908-1910. Additionally, other elements that will be recognized by those skilled in the art may be included in the computing system 1900 but are not explicitly depicted in FIG. 19 or discussed further herein. Various elements of the computer system 1900 may communicate with one another by way of one or more communication buses, point-to-point communication paths, or other communication means not explicitly depicted in FIG. 19.

The processor 1902 may include, for example, a central processing unit (CPU), a microprocessor, a microcontroller, a digital signal processor (DSP), and/or one or more internal levels of cache. There may be one or more processors 1902, such that the processor 1902 comprises a single central-processing unit, or a plurality of processing units capable of executing instructions and performing operations in parallel with each other, commonly referred to as a parallel processing environment.

The computer system 1900 may be a conventional computer, a distributed computer, or any other type of computer, such as one or more external computers made available via a cloud computing architecture. The presently described technology is optionally implemented in software stored on the data stored device(s) 1904, stored on the memory device(s) 1906, and/or communicated via one or more of the ports 1908-1910, thereby transforming the computer system 1900 in FIG. 19 to a special purpose machine for implementing the operations of the coin recycling system 100 described herein. Examples of the computer system 1900 include some or all of the coin recycling system 100, personal computers, terminals, workstations, mobile phones, tablets, laptops, personal computers, multimedia consoles, gaming consoles, set top boxes, and the like.

The one or more data storage devices 1904 may include any non-volatile data storage device capable of storing data generated or employed within the computing system 1900, such as computer executable instructions for performing a computer process, which may include instructions of both application programs and an operating system (OS) that manages the various components of the computing system 1900. The data storage devices 1904 may include, without limitation, magnetic disk drives, optical disk drives, solid state drives (SSDs), flash drives, and the like. The data storage devices 1904 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1906 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1904 and/or the memory devices 1906, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1900 includes one or more ports, such as an input/output (I/O) port 1908 and a communication port 1910, for communicating with other computing, network, or vehicle devices. It will be appreciated that the ports 1908-1910 may be combined or separate and that more or fewer ports may be included in the computer system 1900.

The I/O port 1908 may be connected to an I/O device, or other device, by which information is input to or output from the computing system 1900. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1900 via the I/O port 1908. Similarly, the output devices may convert electrical signals received from computing system 1900 via the I/O port 1908 into signals that may be sensed as output by a human, such as sound, light, and/or touch. The input device may be an alphanumeric input device, including alphanumeric and other keys for communicating information and/or command selections to the processor 1902 via the I/O port 1908. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1900 via the I/O port 1908. For example, an electrical signal generated within the computing system 1900 may be converted to another type of signal, and/or vice-versa. In one implementation, the environment transducer devices sense characteristics or aspects of an environment local to or remote from the computing device 1900, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1900, such as, physical movement of some object (e.g., a mechanical actuator), heating or cooling of a substance, adding a chemical substance, and/or the like.

In one implementation, a communication port 1910 is connected to a network by way of which the computer system 1900 may receive network data useful in executing the methods and systems set out herein as well as transmitting information and network configuration changes determined thereby. Stated differently, the communication port 1910 connects the computer system 1900 to one or more communication interface devices configured to transmit and/or receive information between the computing system 1900 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1910 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 1910 may communicate with an antenna or other link for electromagnetic signal transmission and/or reception.

In an example implementation, characteristic values for known coin types, such as voltage response values, coin sizes, instructions for coin discrimination, singulation, and/or sorting, and software and other modules and services may be embodied by instructions stored on the data storage devices 1904 and/or the memory devices 1906 and executed by the processor 1902. The computer system 1900 may be integrated with or otherwise form part of the coin recycling system 100.

The system set forth in FIG. 19 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for coin sorting comprising:
receiving a batch of coins into a coin singulator;
isolating a coin from the batch of coins on a coin rail using the coin singulator;
measuring a size of the coin using a set of sensors as the coin travels along the coin rail;
measuring one or more voltage responses to one or more signals as the coin passes between a set of inductors on the coin rail;
determining a denomination and a validity of the coin based on the size and the one or more voltage responses; and
ejecting the coin into a chute corresponding to the denomination and the validity.

2. The method of claim 1, wherein a designation of the chute for the denomination and the validity is modifiable without any hardware change.

3. The method of claim 1, wherein the chute is one of a plurality of chutes for the denomination and the validity, each of the plurality of chutes directing coins into one of a plurality of coin hoppers.

4. The method of claim 1, wherein the set of sensors includes one or more optical sensors.

5. The method of claim 1, wherein determining the denomination and the validity of the coin includes comparing a value for the size and a value for each of the one or more voltage responses to a table of known values.

6. The method of claim 1, wherein the one or more signals includes a first signal and a second signal each having a different frequency.

7. The method of claim 1, wherein the coin is ejected using a plunger positioned relative to the chute.

8. The method of claim 1, wherein the coin is ejected from the coin rail into the chute when the coin is determined to be located at an input to the chute.

9. The method of claim 8, wherein the coin is determined to be located at the input to the chute using at least one of a sensor or a determination of a time of travel of the coin along the coin rail until reaching the input to the chute.

10. The method of claim 1, wherein a coin composition for the coin is determined from measuring the one or more voltage responses.

11. The method of claim 1, wherein the set of sensors includes a first sensor and a second sensor and measuring the size of the coin includes measuring a pulse width as the coin passes by the first sensor along the coin rail and measuring a time difference between when the coin passes by the first sensor and when the coin passes by the second sensor.

12. The method of claim 1, wherein the coin is directed through the coin singulator onto the coin rail solely under a force of gravity.

13. The method of claim 1, wherein the coin singulator includes an input bowl mounted to a back plate in a floating arrangement, the floating arrangement displacing the input bowl in a direction away from a wheel in response to a collection of coins of the batch of coins located at the wheel.

14. The method of claim 1, wherein the coin singulator includes one or more surfaces directing each coin of the batch of coins into an upright orientation relative to a face of a wheel, the wheel including one or more holes capturing a single coin from the batch of coins.

15. The method of claim 1, wherein the coin singulator includes a wheel rotated using a motor, a rotation speed of the wheel dynamically adjusted using an encoder.

16. The method of claim 1, wherein the coin is ejected through a rejection chute if at least one of the denomination or the validity is determined to be non-compliant.

17. A system for sorting, the system comprising:
a singulator configured to isolate a disc object from a batch of disc objects;
a rail disposed relative to the singulator, gravity directing the disc object through the singulator onto the rail;
a discriminator determining a size and a composition of the disc object as the disc object travels along the rail, the discriminator determining a denomination and a validity of the disc object based on the size and the composition; and
a sorter in communication with the discriminator, the sorter ejecting the disc object into a chute corresponding to the denomination and the validity.

18. The system of claim 17, wherein the discriminator determines the size of the disc object by measuring a pulse width as the disc object passes by a first sensor along the rail and measuring a time difference between when the disc object passes by the first sensor and when the disc object passes by a second sensor.

19. The system of claim 17, wherein the discriminator determines the composition of the disc object by:
exciting a primary inductor with a first signal when the disc object is located between the primary inductor and a secondary inductor along the rail;
measuring a first response voltage from the secondary inductor to the first signal;
exciting the primary inductor with a second signal having a frequency different from the first signal when the disc object is located between the primary inductor and the secondary inductor; and
measuring a second response voltage from the secondary inductor to the second signal.

20. The system of claim 17, wherein a designation of the chute for the denomination and the validity is modifiable without any hardware change.
